(19) United States
(12) Patent Application Publication
(10) Pub. No.: US 2008/0310202 A1
(43) Pub. Date: Dec. 18, 2008

(54) Method for Automatic Adjustment of the Mains-System Frequency Parameter of a Frequency Converter Which Is Connected to a Mains System

(76) Inventor: Hubert Schierling, Erlangen (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 11/571,018

(22) PCT Filed: Jun. 28, 2005
(86) PCT No.: PCT/EP05/53011

§ 371 Date: Dec. 20, 2006

(30) Foreign Application Priority Data
Jun. 30, 2004 (DE) 10 2004 031 680.5

(51) Int. Cl. H02M 5/458

(52) U.S. Cl. 363/95

(57) ABSTRACT

The invention relates to a method for automatically recognizing a value of the parameter network frequency of a frequency converter connected to a network. According to the invention, the curve of a measured intermediate circuit voltage of the frequency converter is analyzed in order to verify if the network is a 50 Hz or a 60 Hz network, whereupon an analyzed value is entered as parameter network frequency. The frequency converter itself is capable of determining if it is connected to a 50 Hz or 60 Hz network, rendering unnecessary any intervention by a user.

The invention relates to a method for automatic identification of the value of a “mains-system frequency” parameter for a frequency converter which is connected to a feeding mains system.

Information about the rated frequency of the connected motor is required for frequency converters. This is generally identical to the frequency of the feeding mains system. The feeding mains system is a 50 Hz or 60 Hz mains system. The frequency value is used to allow selection of specific control parameters, to allow switching to units of control parameters, and to allow possible rated voltages to be predetermined. The problem is how a frequency converter which is connected to a feeding mains system obtains this information.

In the case of commercially available frequency converters, the mains-system frequency or the motor rated frequency is either entered by the operator by means of a control parameter, is set by means of a switch on the frequency converter, or is measured if provision is made for the recording of the mains-system voltage of a feeding mains system, or at least of its zero crossings. When the operator has to enter the mains-system frequency as a numerical value or has to move a switch to an appropriate setting, it is possible for the operator to forget to do this. The operator will not discover that he has forgotten to define the “mains-system frequency” parameter until the starting-up process has commenced. This means that the operator must shut down the drive again and that he must enter this “mains-system frequency” parameter directly on the frequency converter, which is installed in an installation, by moving an appropriate switch or by entering a numerical value in the frequency converter. He can then commence the initial start-up procedure for the drive again. During this initial start-up procedure, the IEC motor data or the Nema motor data is required as a function of the rated frequency of the motor and/or the frequency of the feeding mains system, and this can in each case be taken from a data plate on the motor that is being used. These two motor data records differ, for example, in that the IEC motor data includes, inter alia, the power factor “cos φ”, and the Nema motor data includes the rating in “horsepower”. When the frequency converter is being operated on a 50 Hz mains system, the power factor of the drive must be entered during the initial start-up procedure. However, if the rating has to be entered in “horsepower”, then the frequency converter is configured for a 60 Hz mains system, and not for a 50 Hz mains system.

The invention is now based on the object of specifying a method by means of which a frequency converter which is connected to a feeding mains system automatically identifies whether the feeding mains system is a 50 Hz or 60 Hz mains system.

This object is achieved according to the invention by the features of claim 1.

The invention comprises the intermediate-circuit voltage, which is already measured for control and protection purposes, of commercially-available frequency converters also being used for automatic identification of the mains-system frequency of a feeding mains system. According to the invention, the profile of this measured intermediate-circuit voltage is analyzed for this purpose, to determine whether this is a 50 Hz or 60 Hz mains system. Since these are the only two mains systems that are used throughout the world, it is not necessary to determine the mains-system frequency of the feeding mains system exactly, and all that is required is to determine whether the mains system that is feeding the frequency converter is a 50 Hz or 60 Hz mains system. This considerably simplifies the complexity for analysis of the profile of the measured intermediate-circuit voltage. The result of this analysis is that the feeding mains system is a 50 Hz or 60 Hz mains system. The result, specifically the value of the mains-system frequency of the feeding mains system, is read as the “mains-system frequency” parameter in the frequency converter which is connected to the feeding mains system. As soon as this value that has been found is entered in the “mains-system frequency” parameter, the process for automatic identification of the mains-system frequency of the mains system which is feeding the frequency converter is complete, so that this process automatically terminates itself.

As a result of the “mains-system frequency” parameter of the frequency converter which is connected to a feeding mains system being defined in advance to have a value zero, the method according to the invention is started automatically when the frequency converter is started up for the first time on a 50 Hz or 60 Hz mains system. The operator of the connected frequency converter therefore just has to switch on this appliance. There is therefore no need for further activation of the method according to the invention, so that activation of the method according to the invention cannot be forgotten.

The method according to the invention can be carried out even during the precharging of an intermediate-circuit capacitor of a voltage intermediate circuit in the frequency converter, or else when the intermediate-circuit voltage reaches a predetermined value. The starting time for the analysis of the profile of the measured intermediate-circuit voltage depends solely on the configuration of a power supply for the electronics in the frequency converter. If the frequency converter cannot be precharged until the power supply for the electronics has been set up, the intermediate-circuit voltage can be analyzed even at the start of the rise in its profile. If a power supply for the electronics starts up with the precharging process, then the analysis of the intermediate-circuit voltage cannot be started until it has reached a predetermined value. Irrespective of this time, the analysis of the profile of the intermediate-circuit voltage is used to determine whether the mains system that is feeding the frequency converter is a 50 Hz or 60 Hz mains system.

The spectral components which are contained in the profile of the measured intermediate-circuit voltage can be determined by means of bandpass filters, correlation analysis or similar frequency analysis methods even if the measurement signals are very small and noisy. A search is carried out for spectral lines at 100 Hz and 300 Hz for a 50 Hz mains system, and at 120 Hz and 360 Hz for a 60 Hz mains system. This means that the aim of the analysis process is not to determine the mains-system frequency of the mains system that is feeding the frequency converter per se, but just to determine which of the two possible mains systems the feeding means systems belongs to. In consequence, the analysis process is not subject to any stringent requirements.

In a further method, a profile of a rectified mains-system voltage is calculated from the profile of the measured intermediate-circuit voltage. This calculated rectified mains-system voltage is evaluated to determine its maxima and minima. The time interval between the voltage maxima and minima is evaluated for this purpose. This time interval in each case has a constant known value for a 50 Hz mains system and a 60 Hz mains system. This means that the result of the time measurement is used to determine whether the feeding mains system is a 50 Hz or 60 Hz mains system.

The invention will be explained further with reference to a drawing, in which the method according to the invention is illustrated schematically, and in which:

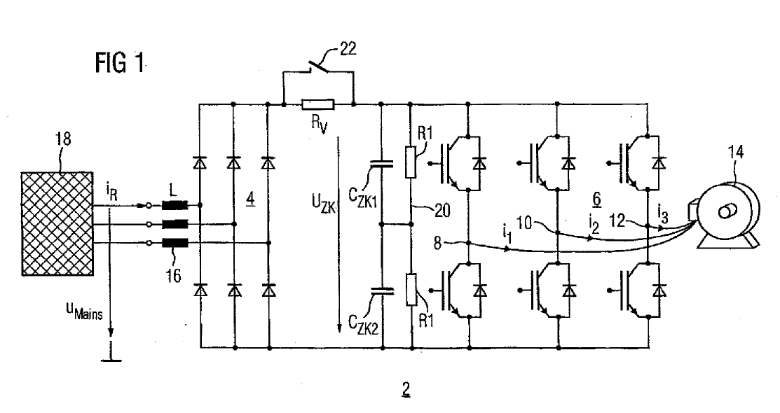

FIG. 1 shows an equivalent circuit of a conventional frequency converter,

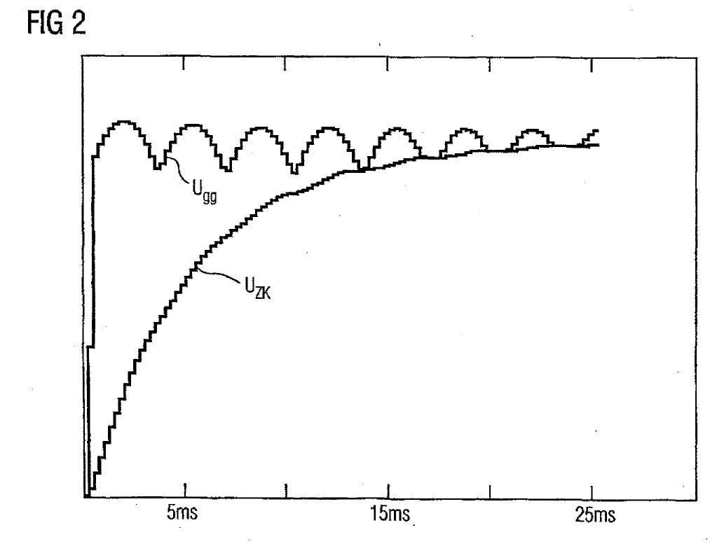

FIG. 2 shows a measured intermediate-circuit voltage in the frequency converter as shown in FIG. 1, and a calculated rectified mains-system voltage in a graph plotted against time t, and

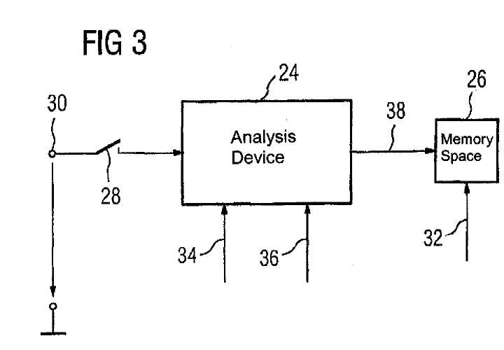

FIG. 3 shows a block diagram of an apparatus for carrying out the method according to the invention

According to the equivalent circuit shown in FIG. 1, a frequency converter 2 has a diode rectifier 4 as a mains-system-side converter, and a self-commutating pulse-controlled converter 6 as a load-side converter. The two converters are electrically conductively linked to one another on the DC-voltage side by means of a DC-voltage intermediate circuit. This DC-voltage intermediate circuit has two intermediate-circuit capacitors C_{IC1} and C_{IC2} connected in series, and two balancing resistors R1 and R2 connected in series. An intermediate-circuit voltage U_{IC} is dropped across the two series-connected intermediate-circuit capacitors C_{IC1} and C_{IC2}. A motor 14 is connected to the phase outputs 8, 10 and 12 of the self-commutating pulse-controlled converter 6. The motor 14 and the frequency converter 2 form a so-called drive. On the input side, this frequency converter 2 has a mains-system commutation inductor 16, which includes an inductance L for each mains-system phase. This frequency converter 2 is connected to a feeding mains system 18 by means of this mains-system commutation inductor 16.

The diode rectifier 4 uses the phase voltages U_{Rmains}, U_{Smains} and U_{Tmains} of the feeding mains system 18 to generate a DC voltage, the intermediate-circuit voltage U_{IC}, which is buffered by means of the two intermediate-circuit capacitors C_{IC1} and C_{CK2}, which are electrically connected in series. For clarity reasons, of these phase voltages U_{Rmains}, U_{Smains} and U_{Tmains} and the phase currents i_{R}, i_{S} and i_{T}, only those for the phase R are illustrated. In order to ensure that these two intermediate-circuit capacitors C_{IC1} and C_{IC2} are charged approximately symmetrically, a balancing circuit 20, comprising the two balancing resistors R1 and R2, is connected electrically in parallel with them. The intermediate circuit is preceded by a precharging circuit, comprising a precharging resistor R_{V} and a relay 22. The relay 24 is connected electrically in parallel with the precharging resistor R_{V} in this precharging circuit. This precharging resistor R_{V} and the intermediate-circuit capacitor C_{IC} result in this precharging circuit having a time constant τ_{VL}. The graph in FIG. 2 shows in more detail and plotted against the time t a measured intermediate-circuit voltage U_{IC} for a sampling time t_{A} of, for example, 250 μs, and a time constant τ_{VL} of, for example, 5 ms.

This graph in FIG. 2 likewise shows a rectified mains-system voltage U_{gg}, which is calculated from the sampled values of the measured intermediate-circuit voltage U_{IC}. This rectified mains-system voltage U_{gg} is calculated using the following equation:

U_{gg}=U_{IC}+R_{V}·C_{IC}·d(U_{IC})/dt (1)

where R_{V} denotes the effective precharging resistance and C_{IC} the intermediate-circuit capacitance of the two intermediate-circuit capacitors C_{IC1} and C_{IC2} which are electrically connected in series. This calculated rectifier mains-system voltage U_{gg} has six sinusoidal peaks within one mains-system period in a manner which is known for six-pulse rectification.

FIG. 3 shows an apparatus for carrying out the method according to the invention. This apparatus has an analysis device 24 and a memory space 26 for the “mains-system frequency” parameter. This memory space 26 follows the analysis device 24. On the input side, this analysis device 24 is electrically conductively linked by means of a switch 28 to one input 30 of this apparatus for carrying out the method according to the invention. The sampled intermediate-circuit voltage U_{IC} is applied to the input 30. The switch 28 is preferably closed automatically when the value 0 is stored in the memory space 26 for the “mains-system frequency” parameter, and the frequency converter 2 is switched on. For this purpose, this apparatus has an advanced-definition channel 32, which is connected to one input of the memory space 26. The analysis device 24 has two input channels 34 and 36. Significant values for a 50 Hz mains system are entered in the analysis device via the input channel 34, and significant values for a 60 Hz mains system are entered in the analysis device via the input channel 36. The analysis method that is used governs what these values are. At the end of the analysis process, either the numerical value “50” or the numerical value “60” is produced at the output of this analysis device 24, and is read by means of the connection 38 to the memory space 26. The numerical value “50” indicates that the analysis of the intermediate-circuit voltage U_{IC} has found that the feeding mains system 18 for the frequency converter 2 is a 50 Hz mains system. In a corresponding manner, the numerical value “60” means that the feeding mains system 18 for the frequency converter 2 is a 60 Hz mains system.

If the sampled intermediate-circuit voltage U_{IC} is evaluated using a frequency-analysis method, then the frequency values 100 Hz and 300 Hz are read in by means of the input channel 34, and the frequency values 120 Hz and 360 Hz are read in by means of the input channel 36. The frequency-analysis method is now used to find out the frequencies at which spectral lines have been determined. If these spectral lines are at 100 Hz or 300 Hz, then the feeding mains system is a 50 Hz mains system, and the numerical value “50” is read into the memory space 26. If the spectral lines occur at 120 Hz and/or 360 Hz, then the feeding mains system is a 60 Hz mains system, so that the numerical value “60” is stored in the memory space 26. The storage of one of these two numerical values ends the method for automatic identification of the mains-system frequency of the feeding mains system 18 for a frequency converter 2.

One simple analysis method comprises the evaluation of the calculated rectified mains-system voltage U_{gg}. In order to allow this rectified mains-system voltage U_{gg} to be calculated, the already stated equation (1) is stored in the analysis device 24. Furthermore, numerical values must be stored for the effective precharging resistance R_{V} and for the intermediate-circuit capacitance C_{IC} of the intermediate-circuit capacitors C_{IC1} and C_{IC2} which are electrically connected in series. The two input channels 34 and 36 are once again used for this purpose. Furthermore, the time intervals between the voltage maxima or minima which occur when the feeding mains system 18 is a 50 Hz mains system or a 60 Hz mains system are stored. In the case of a 50 Hz feeding mains system, these voltage maxima and minima in the rectified mains-system voltage U_{gg} are separated from one another by a time interval of 3.33 ms. In the case of a 60 Hz feeding mains system, the voltage maxima and minima of the rectified mains-system voltage U_{gg} are separated from one another by a time interval of 2.77 ms. By way of example, a counter is started at a first voltage maximum and is reset at the next voltage maximum, with the count change being temporarily stored. This counting process is preferably carried out more than once. These stored counts are then used to form a mean value which is compared with the two predetermined times. If this mean value is approximately equal to the time interval of 3.33 ms, then the numerical value “50” is stored in the subsequent memory space 26. If the mean value corresponds to the time interval 2.77 ms, then the numerical value “60” is stored in the memory space 26.

A further analysis process is carried out as a function of any subsequent charging operations that take place. Subsequent charging of the voltage intermediate circuit in each case takes place at the maximum point of the calculated rectified mains-system voltage U_{gg}. Subsequent charging takes place in the sampling interval k when:

U_{IC}(k+1)−U_{IC}(k−1)>ΔU_{ICmin} (2)

in this case with ΔU_{ICmin} being a discharge that is to be expected. The times (sampling steps k) at which this occurs are stored over a long time period, for example 0.5 s. A check is then carried out on the basis of the first stored value to see whether subsequent charging has taken place again at the interval of:

k=n·k_{2f}+m(n=1,2,3 . . . ; m=−1,0,+1) (3)

In this case, k_{2f} is the number of sampling steps T_{ab} to be expected at 50 Hz and at 60 Hz, respectively, between two subsequent charging processes. In order to provide robustness against unbalanced mains-system voltages, the expected number k_{2f} is advantageously chosen as follows:

k_{2f}=1/(100 Hz ·T_{ab})

for the check at 50 Hz, and

k_{2f}=1/(120 Hz ·T_{ab})

for the check at 60 Hz.

The decision on a 50 Hz or 60 Hz mains system is made as a function of which of the expected numbers k_{2f} gives the greater number of hits. If, for example, the number of hits is less than 25%, then the check is repeated starting with the next subsequent charging process in the stored list.

This method according to the invention means that the frequency converter 2 is itself able to decide whether it has been connected to a 50 Hz or 60 Hz mains system. This means that the previous changeover switch on the frequency converter 2 for switching between a 50 Hz and 60 Hz mains system is no longer required. It is therefore also no longer possible for the operator to forget to move this changeover switch to the appropriate position for the mains-system frequency of the feeding mains system 18. Furthermore, there is no longer any need to record the mains-system voltage. Using this method according to the invention, a frequency converter 2 can thus be connected to a feeding means system 18, and can be started (plug and play).

1. A method for automatic identification of a line frequency of a mains supplying power to a frequency converter, comprising the steps of:
recording a profile of a measured intermediate-circuit voltage of the frequency converter;
analyzing the profile of the measured intermediate-circuit voltage to detect whether the line frequency of the mains is 50 Hz or 60 Hz;
assigning a value to the detected line frequency; and
storing the assigned value as a line system a line frequency parameter in the frequency converter.

2. The method of claim 1, wherein the line frequency parameter is preset before start-up of the frequency converter.

3. The method of claim 2, wherein the line frequency parameter is preset to zero.

4. The method of claim 1, wherein the value is assigned and stored when the frequency converter is first started up.

5. The method of claim 1, wherein the profile of the measured intermediate-circuit voltage is recorded as soon as the frequency converter is connected to the mains.

6. The method of claim 1, wherein the measured intermediate-circuit voltage is analyzed as soon as the frequency converter is connected to the mains.

7. The method of claim 1, wherein the measured intermediate-circuit voltage is analyzed when the intermediate-circuit voltage reaches a predetermined value.

8. The method of claim 1, wherein the measured intermediate-circuit voltage is analyzed by means of a frequency analysis to detect a presence of predetermined spectral lines characteristic of a 50 Hz or 60 Hz line frequency.

9. The method of claim 1 further comprising the steps of calculating from the recorded profile of intermediate-circuit voltage a rectified mains voltage, determining time intervals between maxima or between minima of the calculated rectified mains voltage, and evaluating the time intervals to identify the line frequency.

10. The method of claim 9, wherein the rectified mains voltage is calculated using the following equation:
U_{gg}=U_{IC}+R_{V}·C_{IC}·d(U_{IC})/dt
wherein
U_{IC}=intermediate-circuit voltage
R_{V}=precharging resistance
C_{IC}=intermediate-circuit capacitor.

11. (canceled)

12. (canceled)
